(19) United States
(12) Patent Application Publication
(10) Pub. No.: US 2009/0178104 A1
(43) Pub. Date: Jul. 9, 2009

(54) METHOD AND SYSTEM FOR A MULTI-LEVEL SECURITY ASSOCIATION LOOKUP SCHEME FOR INTERNET PROTOCOL SECURITY

(76) Inventors: Hemal Shah, Trabuco Canyon, CA (US); Protip Roy, San Diego, CA (US)

Correspondence Address: MCANDREWS HELD & MALLOY, LTD, 500 WEST MADISON STREET, SUITE 3400, CHICAGO, IL, 60661, US

(21) Appl. No.: 11/970,957

(22) Filed: Jan. 8, 2008

(51) Int. Cl. G06F 17/00; G06F 21/00

(52) U.S. Cl. 726/1; 726/14

(57) ABSTRACT

Methods and systems for data communication are disclosed and may include utilizing a multi-level lookup process for determining IPsec parameters from a security association database. The security association database may be stored in content addressable memory, and may include an Internet protocol address table, a security association lookup table, and a security association context table. The security association lookup and security association context tables may include a single table. An Internet protocol address table index may be looked up in the Internet protocol address table for a first lookup of the multi-level lookup process. A security protocol index may be looked up utilizing the Internet protocol address table index for a second lookup of the multi-level lookup process. The Internet protocol security parameters may be determined utilizing the security protocol index. IPsec processing may be performed utilizing the determined Internet protocol security parameters.

### CROSS-REFERENCE TO RELATED APPLICATIONS/INCORPORATION BY REFERENCE

[Not Applicable]

### FEDERALLY SPONSORED RESEARCH OR DEVELOPMENT

[Not Applicable]

### MICROFICHE/COPYRIGHT REFERENCE

[Not Applicable]

### FIELD OF THE INVENTION

Certain embodiments of the invention relate to data security. More specifically, certain embodiments of the invention relate to a method and system for a multi-level security association lookup scheme for Internet protocol security.

### BACKGROUND OF THE INVENTION

A computer network is a collection of two or more computing nodes, which are communicatively coupled via a transmission medium and utilized for transmitting information. Most networks adhere to the layered approach provided by the open systems interconnect (OSI) reference model. The OSI reference provides a seven (7) layer approach, which includes an application layer, (Layer 7), a presentation layer (layer 6), a session layer (Layer 5), a transport layer (Layer 4), a network layer (Layer 3), a data link layer (Layer 2) and a physical layer (Layer 1). Layer 7 through layer 5 inclusive may comprise upper layer protocols, while layer 4 through layer 1 may comprise lower layer protocols. These seven layers can be broken down into a fairly specific set of responsibilities or services, which they provide.

Layer 7, the application layer, is typically responsible for supporting network applications such as web browsers and email clients, and is typically implemented in software in end systems such as personal computers and servers. Typical layer 7 protocols comprise HTTP to support the World Wide Web, and SMTP to support electronic mail.

Layer 6, the presentation layer, is typically responsible for masking any differences in data formats that may occur between dissimilar or disparate systems. The presentation layer specifies architecture independent data transfer formats and may enable encoding, decoding, encryption, decryption, compression and/or decompression of data.

Layer 5, the session layer, is typically responsible for managing user session dialogues. In this regard, the session layer may be enabled to control establishment and/or termination of logical links between users. The session layer may also be enabled to provide handling and reporting of upper layer errors.

Layer 4, the transport layer, is typically responsible for passing application layer messages between the client and server sides of an application. In this regard, the transport layer may be enabled to manage end-to-end delivery of messages in the network. The transport layer may comprise various error recovery and/or flow control mechanisms, which may provide reliable delivery of messages. By far the two most common Layer 4 protocols are transmission control protocol (TCP) and user datagram protocol (UDP), which are used in the Internet.

Layer 3, the network layer, is typically responsible for determining how data may be transferred between network devices. Data may be routed according to unique network addresses. In this regard, the network layer may route, for example, datagrams between end systems. Internet Protocol (IP), for example, defines the form and content of the datagrams and is implemented in Layer 3 in combination with any number of routing protocols which may be implemented in the various nodes (devices such as bridges and routers) along a datagram's path from one end system to another.

Layer 2, the data link layer, is typically responsible for moving a packet of data from one node to another. The data link layer defines various procedures and mechanisms for operating communication links and may enable, for example, the framing of packets within the network. The data link layer may enable detection and/or correction of packet errors. The Ethernet (IEEE 802.3) protocol is one common link layer protocol that is used in modern computer networks.

Layer 1, the physical layer, is typically responsible for defining the physical means, which may comprise optical, electrical and/or mechanical means for communicating data via network devices over a communication medium. The converting the bit stream from Layer 2 into a series of physical signals for transmission over a medium. Layer 2 technologies such as Ethernet may implement a number of Layer 1 protocols depending on whether the signal is to be transmitted over twisted-pair cabling or over-the-air for example.

At Layer 3, today's enterprise networks predominantly utilize the Internet Protocol (IP). To enhance network security at Layer 3, a suite of protocols collectively referred to as IPsec was developed and is utilized along with one or more key exchange protocols as a way to provide source authentication, data integrity, and/or data confidentiality of IP datagrams transmitted in a network. In this regard, IPsec may provide end-to-end security of data in a network.

When utilizing IPsec, a source node establishes a logical connection, known as a security association (SA), with a destination node. A security association is a unidirectional connection between the two end nodes and is characterized by the security protocol identifier (AH or ESP), the destination IP address, and a security parameter index (SPI). In this manner, the source node may transmit secure data over the network to the destination node utilizing either the Authentication Header (AH) protocol or the Encrypted Security Payload (ESP) protocol.

At Layer 2, today's enterprise networks are based predominantly on IEEE 802.3 Ethernet technology. While Ethernet offers ubiquitous and inexpensive connectivity to the Enterprise, it is not particularly strong in controlling network access. Although IEEE has attempted to improve access control for wired Ethernet with the IEEE 802.1x standard, this standard did not receive widespread adoption due to a number of reasons. One of these reasons is related to the fact that 802.1x only validated the users as they signed onto the network and it adhered to the one device per port model. There was no per-packet validation, neither was there any standardized method of implementing access control while supporting more than one device per port. Vendors did provide non-standardized means to provide the latter, but the former remained unimplemented.

IEEE standards 802.1AE, 802.1af, and 802.1ar form the basis of a new architecture for network access control for Ethernet networks. These three standards form a replacement for the existing IEEE 802.1x based access control mechanisms. The IEEE 802.1AE (MACsec) standard defines the data link layer encryption and authentication mechanisms. Used in conjunction with 802.1AE, the IEEE 802.1ar standard defines a per-device secure identifier (DevIDs), and IEEE 802.1af defines and recommends procedures to use the DevIDs in an authentication process.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for a multi-level security association lookup scheme for Internet protocol security, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram illustrating a layered Internet protocol model, in accordance with an embodiment of the invention.

FIG 1B is a diagram of an exemplary network that may enable transmitting and receiving internet protocol packets, in accordance with an embodiment of the invention.

FIG. 2 is a block diagram illustrating IP datagrams protected by IPsec in transport and tunnel modes, in accordance with an embodiment of the invention.

FIG. 3 is a block diagram illustrating an exemplary security association databases in accordance with an embodiment of the invention.

FIG. 4 is a block diagram illustrating an exemplary security association database with multi-level lookup, in accordance with an embodiment of the invention.

FIG. 5 is a block diagram illustrating an exemplary application of IPsec in a Windows networking stack, in accordance with an embodiment of the invention.

FIG. 6 is a flow diagram illustrating an exemplary multi-level IP sec security association lookup, in accordance with an embodiment of the invention.

### DETAILED DESCRIPTION OF THE INVENTION

Certain aspects of the invention may be found in a method and system for a multi-level security association lookup scheme for Internet protocol security (IPsec). Exemplary aspects of the invention may comprise utilizing a multi-level lookup process for determining IPsec parameters from a security association database. The security association database may be stored in content addressable memory (CAM). The security association database may comprise an Internet protocol address table, a security association lookup table, and a security association context table. The security association lookup and security association context tables may comprise a single table. An Internet protocol address table index may be looked up in the Internet protocol address table for a first lookup of the multi-level lookup process. A security protocol index may be looked up utilizing the Internet protocol address table index for a second lookup of the multi-level lookup process. The IPsec parameters may be determined utilizing the security protocol index. Internet protocol security processing may be performed utilizing the determined Internet protocol security parameters.

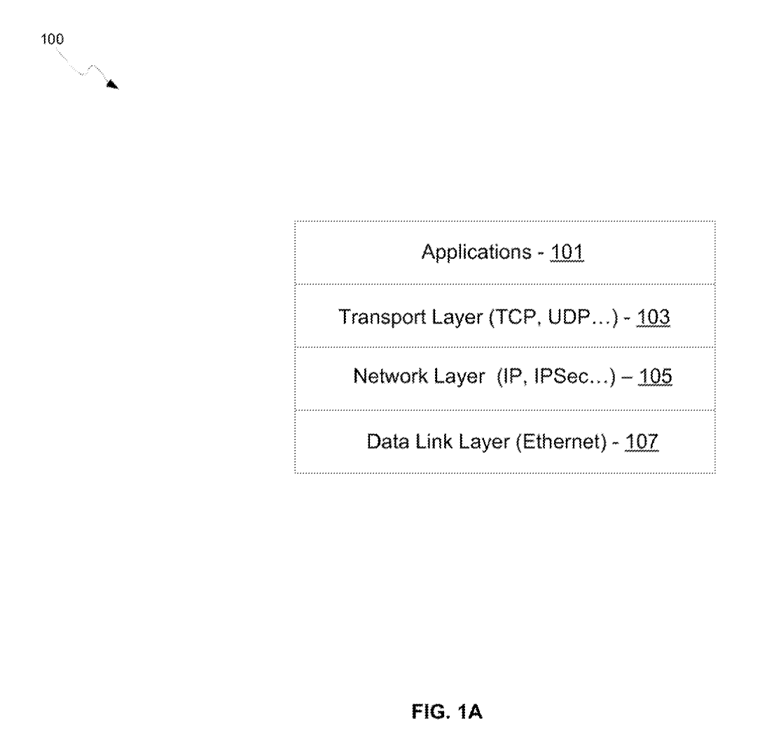

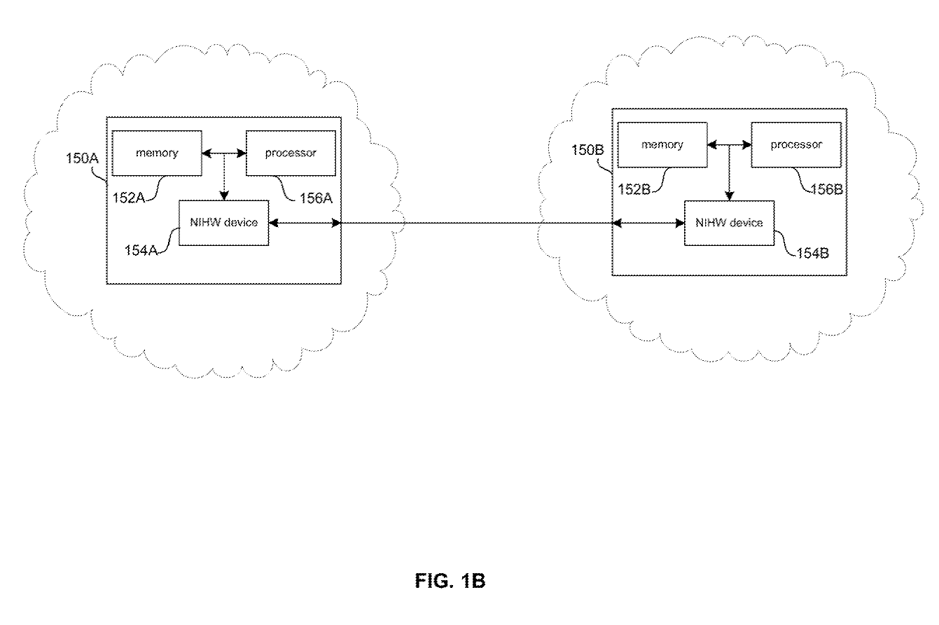

FIG. 1 is a block diagram illustrating a layered Internet protocol model, in accordance with an embodiment of the invention. Referring to FIG. 1, there is shown a layered model 100 comprising an applications layer 101, a transport layer 103, a network layer 105, and a data link layer 107.

The applications layer 101 may comprise software responsible for supporting network applications such as web browsers and email clients. Typical applications layer 101 protocols comprise HTTP to support the World Wide Web, and SMTP to support electronic mail. The applications layer 101 may be used by programs for network communication. Data may be passed from the program in an application-specific format, and then encapsulated into a transport layer protocol.

Since the IP stack may not have any layers between the application and transport layers, in contrast to the OSI reference model, the applications layer 101 may comprise protocols that mimic the OSI presentation and session layer protocols. Data sent over the network may be passed into the applications layer 101 where it may be encapsulated into the application layer protocol. The data may then be passed down into the transport layer 103.

The transport layer 103 may comprise communication protocols for passing application layer messages between the client and server sides of an application. In this regard, the transport layer may be enabled to manage end-to-end delivery of messages in the network. The transport layer may comprise various error recovery and/or flow control mechanisms, which may provide reliable delivery of messages. Common protocols that may be used for Internet transport may comprise transmission control protocol (TCP) and user datagram protocol (UDP).

The transport layer 103 may be responsible for end-to-end message transfer capabilities independent of the underlying network, along with error control, fragmentation and flow control. End-to-end message transmission or connecting applications at the transport layer may be categorized as either connection oriented, which may comprise TCP, or connectionless, which may comprise UDP. The transport layer 103 may be considered a transport mechanism for ensuring that data may reach its destination safely, unless a higher or lower layer may responsible for safe delivery.

The network layer 105 may be responsible for determining how data may be transferred between network devices. Data may be routed according to unique network addresses. In this regard, the network layer 105 may route, for example, datagrams between end systems. The Internet Protocol (IP), for example, defines the form and content of the datagrams and may be implemented in the network layer 105 in combination with any number of routing protocols which may be implemented in the various nodes (devices such as bridges and routers) along a datagram's path from one end system to another.

IPsec may comprise a suite of protocols to provide security and protection for IP datagrams. IPsec may offer security at the network layer 105 to enforce security on all IP-based network traffic. IPsec may use a construct called a security association to associate security services and a key with the traffic to be protected and the remote peer with whom the IPsec traffic may be exchanged. A security association may be identified by a security parameter index, the IPsec protocol value, and the destination address to which the security association applies.

Various traffic security protocols used by IPSec may comprise authentication header and encapsulating security payload. The cryptographic key management may be performed using Internet key exchange protocol. Authentication header and encapsulating security payload may operate in transport mode or tunnel mode. In transport mode, only the upper-layer protocols may be protected. In tunnel mode, the entire IP datagram may be protected by encapsulating the original IP datagram into another IP/IPsec datagram.

In an embodiment of the invention, a multi-level IPsec security association lookup scheme may be utilized that may reduce the size of the security association lookup tables and may allow smaller content addressable memory-based lookup for high-speed implementations.

FIG. 1B is a diagram of an exemplary network that may enable transmitting and receiving internet protocol packets, in accordance with an embodiment of the invention. Referring to FIG. 1B, the exemplary node 150 may comprise a memory 152, a network interface hardware device (NIHW) 154, and a processor 156.

The memory 152 may comprise suitable logic, circuitry, and/or code that may enable storing information utilized for processing of packets. In this regard, the memory 152 may comprise one or more lookup-tables/databases that may enable determining IPsec parameters such as security associations, security association indices, IP address table indices and security association context, as well as one or more control bits that may be utilized by the processor 156 to process and forward the packets.

The NIHW device 154 may comprise suitable logic, circuitry, and/or code that may enable reception and/or transmission of packets in a network. In this regard, the NIHW device 154 may enable reception and transmission of bits over a physical medium and may enable communicating the received bits to the processor 156 and/or the memory 152.

The processor 156 may comprise suitable logic, circuitry, and/or code that may enable the processor 156 to interface with the memory 152 and the NIHW device 154 to receive, process, and forward packets. In this regard, the processor may provide control signals and/or instructions to the memory 152 and the NIHW device 154 that may enable the node 150 to receive and transmit packets.

In operation, a packet may be communicated from node 150A to 150B in the form of a bit-stream over a physical medium. The processor 156A may utilize a multi-step lookup to determine IPsec parameters to be utilized in securely communicating the packet from the NIHW 154A to the NIHW device 154B. Accordingly, an IPsec header may be incorporated in the packet to be communicated via transport-mode protection. In another embodiment of the invention, a tunnel-mode header and an IPsec header may be incorporated into the packet to be communicated via tunnel-mode protection.

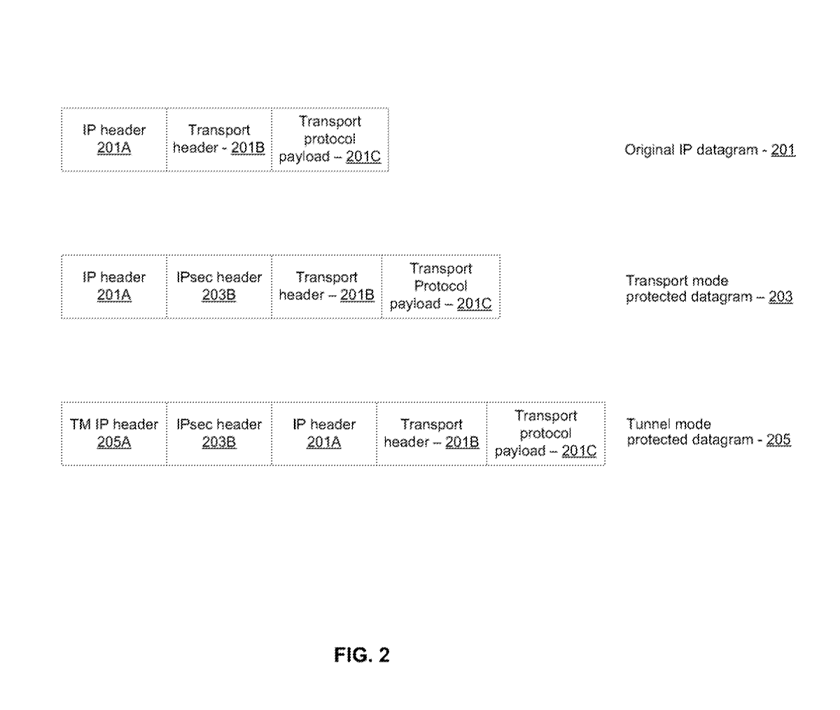

FIG. 2 is a block diagram illustrating IP datagrams protected by IPsec in transport and tunnel modes, in accordance with an embodiment of the invention. Referring to FIG. 2, there is shown an original IP datagram 201, a transport-mode protected datagram 203 and a tunnel-mode protected datagram. The IPsec protocol may utilize a security association to associate security services and a key with the traffic to be protected and the remote peer with whom the IPsec traffic may be exchanged. An IPsec security association may be uni-directional as it may define security services for one direction, either inbound for packets received or outbound for the packets that may be secured and sent. Typically, security associations may exist in pairs, one in each direction. The security associations may be created manually or dynamically. A security association may have no lifetime when created manually. In instances where a security association may be created dynamically, it may have a lifetime associated with it. The security association may be stored in a security association database. A security association may be identified by a security parameter index, the IPsec protocol value, and the destination address to which the security association may apply.

The original IP datagram 201 may comprise an IP header 201A, a transport header 201B and a transport protocol payload 201C. The IP header 201A may comprise control information utilized to route the IP datagram from a source IP address to a destination IP address. The transport header 201B may comprise a TCP and/or UDP header, for example, which may comprise information relating to the datagram, such as a source port, a destination port, the length, in bytes, of the original IP datagram 201, and a checksum for error correction. The transport header 201B may be utilized for TCP or UDP protocols.

The transport-mode protected datagram 203 may comprise the IP header 201A, an IPsec header 203B, the transport header 201B and the transport protocol payload 201C. The IPsec header 203B may comprise authentication header payload information. An authentication header may comprise information utilized by a receiver to identify the security association and corresponding information associated with the transport-mode protected datagram 203, validate and authenticate the transport-mode protected datagram 203, and determine how to process the IPsec layer of the transport-mode protected datagram 203. In this regard, a transmitter generating the transport-mode protected datagram 203 may determine a security association for the transport-mode protected datagram 203 and may utilize the security association to generate the IPsec header 203B. In this manner, various embodiments of the invention may utilize datagrams in the format of the transport-mode protected datagram 203 to transmit information securely over a network.

Similarly, the IPsec header 203B may comprise encapsulating security payload information. An encapsulating security payload header may comprise information utilized by a receiver to identify the security association, and corresponding information, associated with the transport-mode protected datagram 203, validate and authenticate the transport-mode protected datagram 203, and determine how to process the IPsec layer of the transport-mode protected datagram 203. In this regard, a transmitter generating the transport-mode protected datagram 203 may determine a security association for the transport-mode protected datagram 203 and may utilize the security association to generate the IPsec header 203B. The ESP protocol may be utilized to encrypt the contents of the ESP payload.

In transport mode, only the transport header 201B and the transport payload 201C may be encrypted and/or authenticated. The routing information may be intact, since the IP header may not be modified or encrypted. The transport and application layers may be secured by an authentication digest, so they may not be modified. Additionally, the transport and application layers may be protected by the encryption at the ESP layer. Transport mode may be used for host-to-host communications.

The tunnel-mode protected datagram 205 may comprise a tunnel-mode IP header 205A, the IPsec header 203B, the IP header 201A, the IP datagram 201 or IP fragment payload (which may contain the transport header 201B and the transport protocol payload 201C). In tunnel mode, the entire IP packet may be encrypted and encapsulated into a new packet with a new header, the tunnel-mode IP header 205A. The tunnel-mode IP header 205A may comprise control and security information utilized to securely route the IP datagram from a source IP address to a destination IP address

In operation, various embodiments of the invention may utilize datagrams in the format of the transport-mode protected datagram 203 or the tunnel-mode protected datagram 205 to transmit information securely over a network. A multi-level security association scheme may reduce storage requirements as compared to a single-level lookup process may store redundant IP address information, for example.

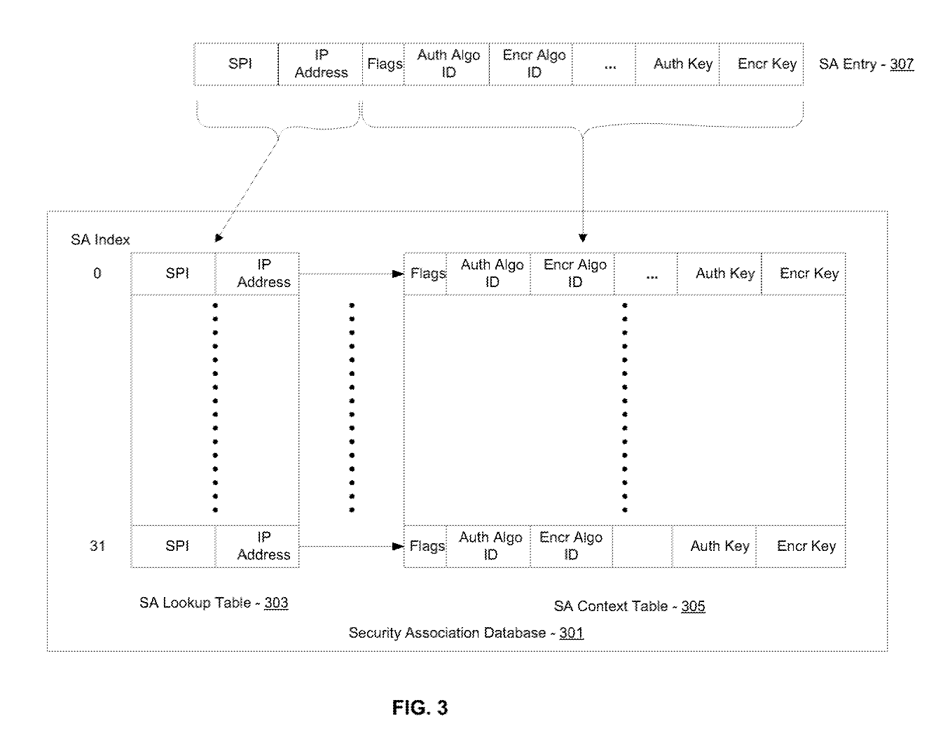

FIG. 3 is a block diagram illustrating an exemplary security association database, in accordance with an embodiment of the invention. Referring to FIG. 3, there is shown a security association database 301 comprising an array of data fields each row of which may comprise a security association entry 307. Each secure association entry 307 may comprise a security parameter index, an IP address, flags, an authentication algorithm ID, an encryption algorithm ID, and authentication key and an encryption key, for example. The rows of the security parameter indices and the IP addresses may comprise a lookup table 303, which may comprise the fields required for a lookup. The rows of flags, authentication algorithm IDs, encryption algorithm IDs, authentication keys and encryption keys may comprise the security association context table 305.

In operation, the secure association database 301 may be stored in content addressable memory and may comprise IPsec protocol data. The lookup table 303 may be utilized to determine the security association given a destination IP address. An exemplary lookup algorithm may be given by the following pseudocode:

```
If (this is an IPsec packet) then
    SA Index = Lookup ([SPI, IP Address, Protocol], lookup table)
    If (SA index is valid) then
        Lookup succeeded; Use SA index to access security access
    context table to obtain flags, algorithm IDs and authentication and
    encryption keys.
    Else
        Lookup failed
Else
    No need to perform lookup
```

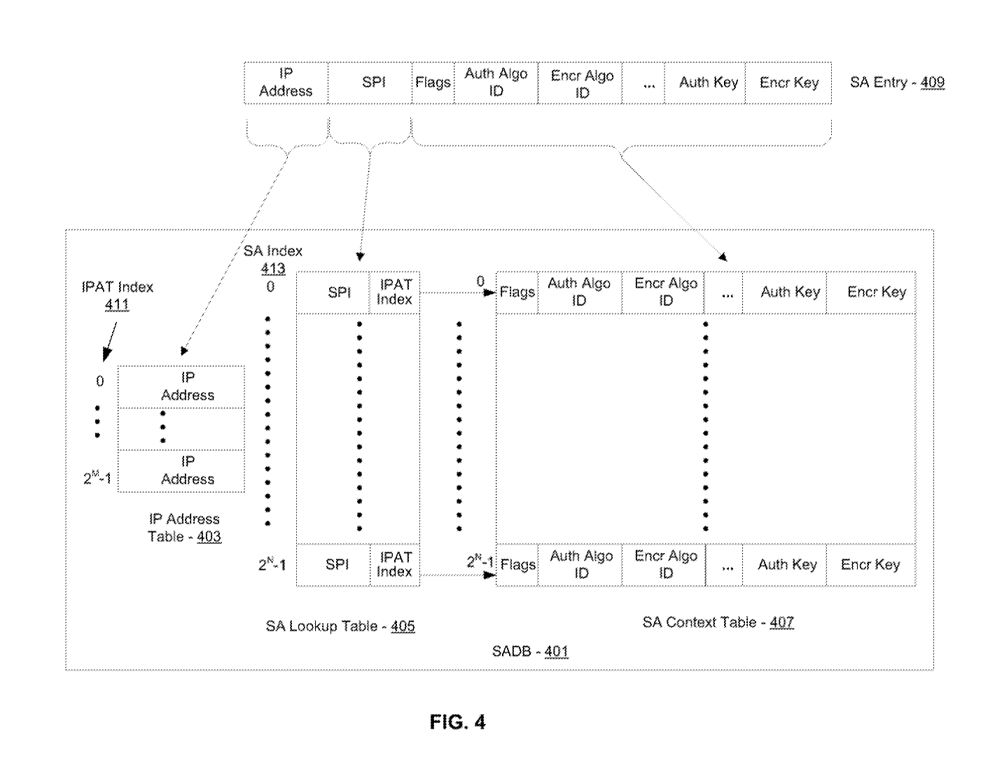

FIG. 4 is a block diagram illustrating an exemplary security association database with two-level lookup, in accordance with an embodiment of the invention. Referring to FIG. 4, there is shown a security association database 401 comprising an IP address table 403, a security association lookup table 405, a security association context table 407, a security association entry 409, an IP address table index 411 and a security association lookup table index 413. The security association entry 409 may be substantially similar to the security association entry 307 described with respect to FIG. 3.

The IP address table 403 may comprise a table of 2^{M}−1 IP addresses, each row of the IP address table 403 corresponding to an index, the IP address table index 411. The IP address table index 411 may also correspond to a column in the security association lookup table 405, indicated by IPAT Index, which may comprise 2^{N}−1 rows. The other column in the security association lookup table 405 may comprise the security parameter index, SPI. The rows of the security association lookup table 405 may correspond to the security association lookup table index 413.

On a given node, it may be possible that the number of IP addresses used may be limited to a small number, 1, 3 or 4, for example. The lookup table storage may thus be reduced by performing a hierarchical two-level lookup, for example. First, the destination IP address may be utilized to determine the IP address table index 411 followed by the lookup of the security association index 413 using the security parameter index, SPI, and the IP address table index 411. This multi-level lookup may reduce the content addressable memory size and the total size of the lookup tables. However, the two-level lookup may increase the lookup time since two lookup may be required. Notwithstanding, for a high-speed implementation, this increase may represent an increase of one processing cycle compared to the entire budget of processing cycles for a packet, which may comprise tens or hundreds of cycles.

In an exemplary embodiment of the invention, the multi-level lookup scheme may utilize two tables used for the lookup: the IP address table 403 and the security association lookup table 405. The number of entries in the IP address table 403, M may be significantly lower than the number of entries in security association lookup table 405, N(N<<M). For this scheme, the security association lookup table 405 may only store the IP address table index 411 instead of the IP address. The multi-level lookup algorithm may be described by the following code:

```
If (this is an IPsec packet) then
  IPAT Index = Lookup (IP Address, IPAT)
  If (IPAT Index is valid) then
    SA Index = Lookup ([SPI, IPAT Index, Protocol], lookup table)
    If (SA Index is valid) then
      Lookup succeeded; Use security association Index to access the
      security association context table and perform IPsec processing.
    Else
      Lookup failed.
  Else
    Lookup failed.
Else
  No need to perform lookup.
```

The lookup table storage requirements, in bits, for one-level and two-level lookup schemes are compared in the following table:

| | IPv4 | IPv6 |
|---|---|---|
| One-Level | N * 64 bits | N * 160 bits |
| Lookup | | |
| Scheme | | |
| Two-Level | N * (32 + ceiling(log₂M)) + | N * (32 + ceiling(log₂M)) + |
| Lookup | M * 32 bits | M * 128 bits |
| Scheme | | |

In an exemplary embodiment, where M=2 and N=65536, the storage requirements are shown in the following table:

| | IPv4 | IPv6 |
|---|---|---|
| One-Level Lookup Scheme | 4194304 bits | 10485760 bits |
| Two-Level Lookup Scheme | 2162752 bits | 2162944 bits |

Thus, the lookup table storage requirements may be halved for IPv4 and reduced by nearly 80% for IPv6 by utilizing the two-level lookup scheme. In another embodiment of the invention, the security association lookup table 405 and the security association context table 407 may comprise conceptually separate tables, but may be co-located in a single table.

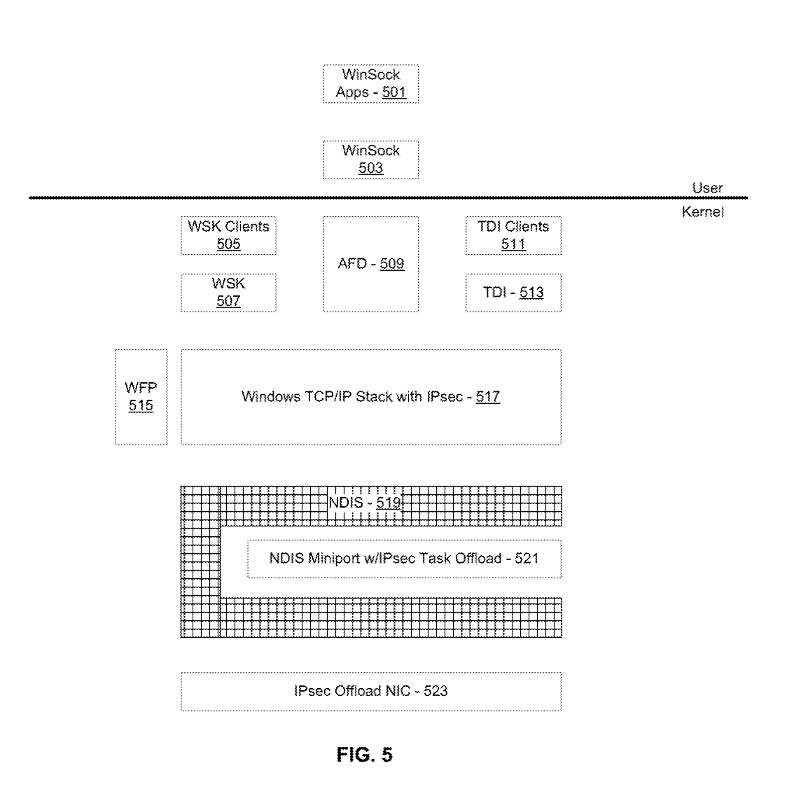

FIG. 5 is a block diagram illustrating an exemplary application of IPsec in a Windows networking stack, in accordance with an embodiment of the invention. Referring to FIG. 5 there is shown WinSock applications 501, a WinSock block 503, a Windows sockets kernel (WSK) clients block 505, an ancillary function driver (AFD) block 509, a transport driver interface (TDI) clients block 511, a TDI module 513, a Windows filter platform (WFP) 515, a Windows TCP/IP stack with IPsec block 517, a network driver interface specification (NDIS) block 519, an NDIS miniport with IPsec task offload block 521 and an IPsec offload network interface card (NIC) 523.

The WinSock block 503 may comprise suitable logic, circuitry and/or code that may enable user mode implementation of the Windows sockets. The WinSock block 503 may contain a layer of libraries comprising WinSock DLL and Microsoft's base service provider for TCP/IP. The WinSock applications 501 may comprise software code for providing an interface between the Winsock block 503 libraries and external user applications.

The WSK block 507 may comprise the kernel mode implementation of sockets, which may be used by kernel mode sockets applications. WSK may comprise the kernel-mode programming interface that may be designed to eventually replace the Transport Driver Interface (TDI) in Windows XP and Windows Server 2003. The WSK block 507 may communicate with the Windows TCP/IP stack with IPsec block 517. The WSK clients block 505 may comprise an interface for clients to utilize the WSK block 507.

The AFD block 509 may comprise the kernel mode sockets driver for the WinSock block 503. The Microsoft sockets provider may call into the AFD block 509 to access Windows TCP/IP stack with IPsec block 517.

The TDI module 513 may comprise the legacy kernel mode interface that may be exposed at the upper edge of the transport protocols. The TDI transport provider may communicate with the Windows TCP/IP stack with IPsec block 517. The TDI clients block 511 may comprise an interface for clients to utilize the TDI module 513.

The Windows TCP/IP stack with IPsec block 517 may comprise a completely rewritten TCP/IP stack in Windows Vista and Longhorn with the support for IPv4, IPv6, and IPSec, and may be referred to as NetIO stack.

The NDIS block 519 may comprise the layer that provides the interface for the Windows TCP/IP stack with IPsec block 517 at the top. At the bottom, the NDIS block 519 may manage the IPsec offload NIC 523, including the sending and/or receiving of data. The NDIS miniport with IPsec task offload block 521 may comprise two functions: first, Interfacing with higher-level drivers, such as intermediate drivers and transport protocol drivers; and second, managing a NIC, such as the IPsec offload NIC 523, including sending and receiving data through the NIC. The NDIS miniport with IPsec task offload block 521 may communicate with the IPsec offload NIC 523 and with the higher-level drivers using an NDIS library.

The IPsec offload NIC 523 may comprise suitable circuitry, logic and/or code that may enable communication between a computer and a network utilizing the IPsec protocol. The IPsec offload NIC 523 may communicate with the NDIS block 519.

In operation, the IPsec functions may be split between a host stack and the offload target. In the IPsec task offload architecture, the host may be responsible for the IPsec header formation, creation, and stripping. The host stack may also perform the anti-replay service and IP header processing. The host stack may handle IP fragmentation/reassembly as well as all the IPsec/IP processing for IP fragments. The security policy related checks may be handled by the host stack.

The host stack may offload IPsec authentication digest computation and/or verification and IPsec encryption/decryption tasks to the offload target. For the offloaded security associations, the IPsec offload NIC 523 may be responsible for performing cryptographic operations on the packets. The IPsec offload NIC 523 may comprise a subset of the host stack security association database. The host may use add and delete operations to manage offloaded security associations.

The IPsec task offload architecture may allow the IPsec offload NIC 523 to advertise its offloading capabilities. The IPsec offload NIC 523 may support offloading of IPsec tasks in transmit path only, or receive path only, or both paths. The IPsec task offload architecture may enable an implementation to support various combinations including authentication algorithms, IPsec protocols, encryption algorithms, and transport/tunnel modes, for example.

In an embodiment of the invention, the Windows TCP/IP stack with IPsec block 517 may perform a plurality of IPsec tasks: In the transmit data path: IPsec packet formation with header(s) and trailer, SPI insertion, anti replay sequence generation and/or insertion, padding and setting next header field, and IP fragmentation, if needed. In the receive data path: anti-replay sequence checks, stripping of padding, IPsec header(s) and trailer stripping, security policy checks, and IP reassembly and processing of fragmented packets. In addition, the Windows TCP/IP stack with IPsec block 517 may perform NDIS IPsec offload request initiation and/or completion, and offloading of security associations.

The NDIS miniport with IPsec task offload block 521 may perform NDIS IPsec task offload Tx/Rx request handling, NDIS add/delete security association request handling, Tx and Rx descriptor posting and/or completion, security association validation of transmit, and NIC security association database operations, such as addition and deletion.

The IPsec offload NIC 523 may perform Tx and/or Rx descriptor processing. In the transmit path, functions may comprise encryption, authentication digest computation and/or insertion. In the receive path, the functions may comprise security association lookup, authentication digest computation and/or verification, and decryption. In addition, the IPsec offload NIC 523 may perform NIC security association database management.

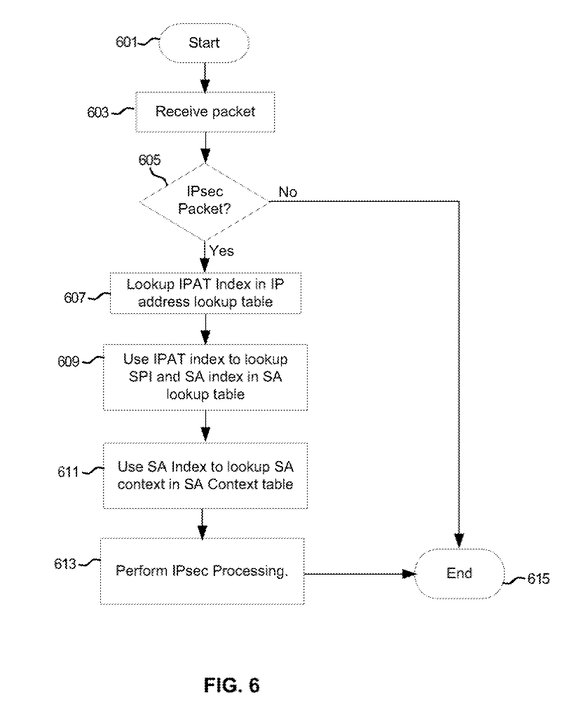

FIG. 6 is a flow diagram illustrating an exemplary two-level IP sec security association lookup, in accordance with an embodiment of the invention. Referring to FIG. 6, in step 603, after start step 601, the data packet may be received. In step 605, if the received data packet does not comprise an IPsec data packet, the exemplary steps may proceed to end step 615. In instances where the received data packet comprises an IPsec data packet, the process may proceed to step 607, where the IPAT index may be looked up in the IP address lookup table, before proceeding to step 609. In step 609, the IPAT index may be utilized to lookup SPI and the SA index in the SA lookup table, followed by step 611, where the SA index may be utilized to lookup the SA context in the SA context table. In step 613, the IPsec processing may be performed, followed by end step 615.

In an embodiment of the invention, a method and system are disclosed for utilizing a multi-level lookup process for determining IPsec parameters from a security association database. The security association database may be stored in content addressable memory. The security association database may comprise an Internet protocol address table, a security association lookup table, and a security association context table. The security association lookup and security association context tables may comprise a single table. In an exemplary embodiment of the invention, in a two-level lookup, an Internet protocol address table index may be looked up in the Internet protocol address table for a first lookup of the two-level lookup process. A security protocol index may be looked up utilizing the Internet protocol address table index for a second lookup of the two-level lookup process. The IPsec parameters may be determined utilizing the security protocol index. Internet protocol security processing may be performed utilizing the determined Internet protocol security parameters.

Certain embodiments of the invention may comprise a machine-readable storage having stored thereon, a computer program having at least one code section for communicating information within a network, the at least one code section being executable by a machine for causing the machine to perform one or more of the steps described herein.

Accordingly, aspects of the invention may be realized in hardware, software, firmware or a combination thereof. The invention may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

The present invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for data communication, the method comprising:
in a network layer device, determining Internet protocol security (IPsec) from a security association database via a multi-level lookup which utilizes a plurality of indices to determine Internet protocol security parameters.

2. The method according to claim 1, wherein said security association database is stored in content addressable memory.

3. The method according to claim 1, wherein said security association database comprises an Internet protocol address table, a security association lookup table, and a security association context table.

4. The method according to claim 3, wherein said security association lookup table and said security association context table comprise a single table.

5. The method according to claim 3, comprising looking up an Internet protocol address table index in said Internet protocol address table for a first lookup of said multi-level lookup process.

6. The method according to claim 5, comprising looking up a security protocol index utilizing said Internet protocol address table index for a second lookup of said multi-level lookup process.

7. The method according to claim 6, comprising determining said IPsec parameters utilizing said security protocol index.

8. The method according to claim 7, comprising performing IPsec processing utilizing said determined Internet protocol security parameters.

9. A system for data communication, the system comprising:
one or more circuits in a network layer device, said one or more circuits determines Internet protocol security (IPsec) from a security association database via a multi-level lookup which utilizes a plurality of indices to determine Internet protocol security parameters.

10. The system according to claim 9, wherein said security association database is stored in content addressable memory.

11. The system according to claim 9, wherein said security association database comprises an Internet protocol address table, a security association lookup table, and a security association context table.

12. The system according to claim 11, wherein said security association lookup table and said security association context table comprise a single table.

13. The system according to claim 11, wherein said one or more circuits look up an Internet protocol address table index in said Internet protocol address table for a first lookup of said multi-level lookup process.

14. The system according to claim 13, wherein said one or more circuits look up a security protocol index utilizing said Internet protocol address table index for a second lookup of said multi-level lookup process.

15. The system according to claim 14, wherein said one or more circuits determines said IPsec parameters utilizing said security protocol index.

16. The system according to claim 15, wherein said one or more circuits enables IPsec processing utilizing said determined Internet protocol security parameters.

17. A machine-readable storage having stored thereon, a computer program having at least one code section for data communication, the at least one code section being executable by a machine for causing the machine to perform steps comprising:
in a network layer device, determining Internet protocol security (IPsec) from a security association database via a multi-level lookup which utilizes a plurality of indices to determine Internet protocol security parameters.

18. The machine readable storage according to claim 17, wherein said security association database is stored in content addressable memory.

19. The machine readable storage according to claim 17, wherein said security association database comprises an Internet protocol address table, a security association lookup table, and a security association context table.

20. The machine readable storage according to claim 19, wherein said security association lookup table and said security association context table comprise a single table.

21. The machine readable storage according to claim 19, wherein said at least one code section comprises code for looking up an Internet protocol address table index in said Internet protocol address table for a first lookup of said multi-level lookup process.

22. The machine readable storage according to claim 21, wherein said at least one code section comprises code for looking up a security protocol index utilizing said Internet protocol address table index for a second lookup of said multi-level lookup process.

23. The machine readable storage according to claim 22, wherein said at least one code section comprises code for determining said IPsec parameters utilizing said security protocol index.

24. The machine readable storage according to claim 23, wherein said at least one code section comprises code for enabling IPsec processing utilizing said determined Internet protocol security parameters.
